(19) United States
(12) Patent Application Publication
(10) Pub. No.: US 2024/0250323 A1
(43) Pub. Date: Jul. 25, 2024

(54) INDIVIDUAL POUCH CELL TEMPERATURE MONITORING SYSTEM FOR THERMAL RUNAWAY PROTECTION MITIGATION

(71) Applicant: GM GLOBAL TECHNOLOGY OPERATIONS LLC, Detroit, MI (US)

(72) Inventors: Ratandeep Singh KUKREJA, Auburn Hills, MI (US); Michael P. BALOGH, Novi, MI (US); Daad Bourhan HADDAD, Warren, MI (US); Mark W. VERBRUGGE, Troy, MI (US)

(21) Appl. No.: 18/100,187

(22) Filed: Jan. 23, 2023

(51) Int. Cl. H01M 10/48; H01M 10/42

(52) U.S. Cl. CPC H01M 10/486; H01M 10/425; H01M 10/482; H01M 10/0525

(57) ABSTRACT

A battery system includes: a battery cell; and a temperature sensing array disposed on a surface of the battery cell, the temperature sensing array including: a conducting strip; and a plurality of temperature sensors connected in series with the conducting strip such that current flowing through the conducting strip flows through each of the temperature sensors, where each of the plurality of temperature sensors has at least one characteristic that varies in accordance with temperature, where the plurality of temperature sensors is distributed in different locations across the surface of the battery cell, and where an output current of the temperature sensing array varies in accordance with a change in temperature in any of the different locations.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for monitoring temperatures of battery pouch cells.

A battery or battery system (e.g., a rechargeable battery for electric and/or hybrid electric vehicles) may include a plurality of battery cells. Types of rechargeable batteries include, but are not limited to, lithium ion, lithium-sulfur (Li—S), lithium metal, and/or other types of rechargeable batteries. The battery cells may be implemented as battery pouch cells.

### SUMMARY

In a feature, a battery system includes: a battery cell; and a temperature sensing array disposed on a surface of the battery cell, the temperature sensing array including: a conducting strip; and a plurality of temperature sensors connected in series with the conducting strip such that current flowing through the conducting strip flows through each of the temperature sensors, where each of the plurality of temperature sensors has at least one characteristic that varies in accordance with temperature, where the plurality of temperature sensors is distributed in different locations across the surface of the battery cell, and where an output current of the temperature sensing array varies in accordance with a change in temperature in any of the different locations.

In further features, the temperature sensors each include a plurality of low melting point alloy (LMPA) traces connected in parallel with each other and in series with the conducting strip.

In further features, each of the LMPA traces has a different melting point.

In further features, the temperature sensors each include a temperature sensing component connected in series with the conducting strip.

In further features, the temperature sensing component includes at least one of a resistance thermometer, a thermistor, and a diode.

In further features, the conducting strip follows a serpentine path across the surface of the battery cell.

In further features, the battery system includes a plurality of the temperature sensing arrays.

In further features, a system includes the battery system and a temperature monitoring system configured to supply one of a voltage and a current to the temperature sensing array, receive the output current of the temperature sensing array, and determine a temperature of the battery cell based on the output current.

In further features, the battery system includes a plurality of the battery cells.

In further features, the battery cells are one of pouch cells, prismatic cells, and cylindrical cells.

In further features, the temperature monitoring system is configured to disconnect a selected one or more of the pouch cells from the battery system in response to a determination that the temperature of the one or more battery cells exceeds a predetermined temperature.

In further features, the pouch cells are lithium-ion pouch cells.

In further features, a vehicle including the system above.

In a feature, a system for a vehicle includes: a battery system, the battery system including a plurality of pouch cells; a plurality of temperature sensing arrays disposed on respective surfaces of each of the pouch cells, where each of the plurality of temperature sensing arrays includes: a conducting strip, and a plurality of temperature sensors connected in series with the conducting strip such that current flowing through the conducting strip flows through each of the temperature sensors, where each of the plurality of temperature sensors has at least one characteristic that varies in accordance with a temperature of the pouch cell, where the plurality of temperature sensors is distributed in different locations across the respective surface of the pouch cell, and where an output current of the temperature sensing array varies in accordance with a change in temperature in any of the different locations; and a temperature monitoring system configured to receive the output currents of each of the temperature sensing arrays and determine the temperatures of the pouch cells based on the output currents.

In further features, each of the plurality of temperature sensors includes a plurality of low melting point alloy (LMPA) traces connected in parallel with each other and in series with the conducting strip.

In further features, each of the LMPA traces has a different melting point.

In further features, each of the plurality of temperature sensors includes at least one of a resistance thermometer, a thermistor, and a diode.

In further features, the conducting strip follows a serpentine path including multiple changes in direction across the surface of the pouch cell.

In further features, the plurality of temperature sensors are connected in parallel across a full width of the pouch cells.

In further features, the temperature monitoring system is configured to disconnect a selected one or more of the pouch cells from the battery system in response to a determination that the temperature of the pouch cell exceeds a predetermined temperature.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIGS. 2A and 2B show an example battery cell;

FIGS. 3A, 3B, 3C, 3D, and 3E show example temperature sensing arrays for a battery cell;

FIGS. 4A and 4B show example temperature sensors of a temperature sensing array; and

FIG. 5 is a functional block diagram of an example battery system and temperature monitoring system.

In the drawings, reference numbers may be reused to identify similar and/or identical elements.

### DETAILED DESCRIPTION

Defects in battery cells such as pouch cells (e.g., discontinuities such as full or partial tears, blisters, and/or cracks in the collector foils, weld failures, air or gas bubbles, etc.) may cause battery cell failure and other faults, such as thermal runaway. Thermal runaway (or thermal runaway propagation (TRP)) may refer to a condition where heat generated by a battery cell or battery module exceeds an amount of heat that is dissipated to the environment. When this occurs, the temperature of one battery may cause other batteries in the battery system to also be heated at a rate that exceeds heat dissipation.

Battery systems with some types of battery cells (e.g., Li-ion battery (LIB) pouch cells) do not have the capability of monitoring the temperature of individual battery cells (e.g., pouch cells). For example, providing thermocouples or other sensing devices to individual pouch cells increases both cost and weight of a battery pack.

Temperature monitoring systems and methods according to the present disclosure are configured to monitor respective temperatures of individual or multiple pouch cells. Based on the monitored temperatures, a battery system can be controlled to reduce temperatures of selected pouch cells, disconnect selected pouch cells from other cells in the battery system, etc.

As one example, one or more temperature sensing traces (e.g., a temperature sensing array) are attached to a surface of a pouch cell. For example, the temperature sensing traces are implemented as thin strips of low melting point alloys (LMPAs), strips of dielectric material with a linear change in resistance with changes in temperature, etc. A current is supplied to the traces and monitored. As temperature of the pouch cell increases, the sensed current changes and is indicative of the temperature of the pouch cell. For example, in systems where LMPAs are used, portions of the traces melt as the temperature increases and the sensed current changes accordingly. In other words, portions of the traces function as thermal fuses. Conversely, in systems where dielectric material is used, the resistance decreases (or, in some examples, increases) as temperature increases and the sensed current changes accordingly. The temperature sensing traces may implement other types of materials having different physical and/or electrical characteristics that change with temperature.

Although described herein with respect to vehicle batteries (e.g., rechargeable batteries for electric or hybrid vehicles), the principles of the present disclosure may be applied to batteries used in non-vehicle applications.

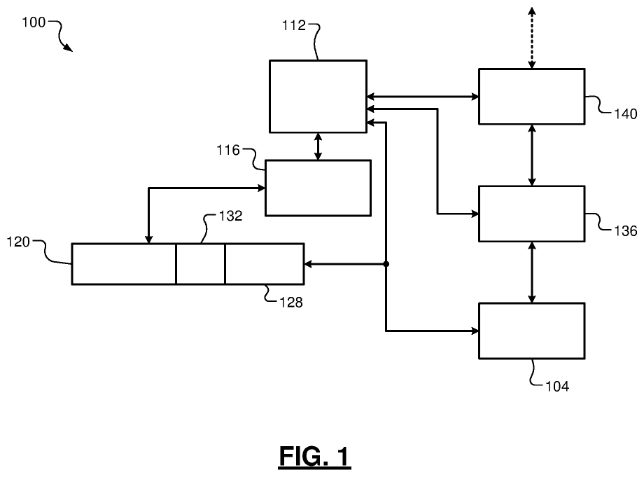

Referring now to FIG. 1, a functional block diagram of an example vehicle system 100 including a battery system 104 according to the present disclosure is shown. The vehicle system 100 may correspond to an autonomous or non-autonomous vehicle. The vehicle may be an electric vehicle (as shown). In other examples, the principles of the present disclosure may be implemented in a hybrid electric vehicle or a non-vehicle application.

A vehicle control module 112 controls various operations of the vehicle system 100 and an engine (e.g., acceleration, braking, etc.). The vehicle control module 112 may communicate with a transmission control module 116, for example, to coordinate gear shifts in a transmission 120. The vehicle control module 112 may communicate with the battery system 104, for example, to coordinate operation of an electric motor 128. While the example of one electric motor is provided, multiple electric motors may be implemented. The electric motor 128 may be a permanent magnet electric motor or another suitable type of electric motor that outputs voltage based on back electromagnetic force (EMF) when free spinning, such as a direct current (DC) electric motor or a synchronous electric motor. In various implementations, various functions of the vehicle control module 112 and the transmission control module 116 may be integrated into one or more modules.

Electrical power is applied from the battery system 104 to the electric motor 128 to cause the electric motor 128 to output positive torque. For example, the vehicle control module 112 may include an inverter or inverter module (not shown) to apply the electrical power from the battery system 104 to the electric motor 128. The electric motor 128 may output torque, for example, to an input shaft of the transmission 120, to an output shaft of the transmission 120, or to another component. A clutch 132 may be implemented to couple the electric motor 128 to the transmission 120 and to decouple the electric motor 128 from the transmission 120. One or more gearing devices may be implemented between an output of the electric motor 128 and an input of the transmission 120 to provide one or more predetermined gear ratios between rotation of the electric motor 128 and rotation of the input of the transmission 120.

A battery control module (comprising, for example, a vehicle management system, a battery management system, etc.) 136 is configured to control functions of the battery system 104 including, but not limited to, controlling switching of individual battery modules or cells of the battery system 104, monitoring operating parameters, diagnosing faults, etc. The battery control module 136 may be further configured to communicate with a telematics module 140. The battery system 104 according to the principles of the present disclosure includes a temperature monitoring system configured to monitor temperatures of individual battery cells (e.g., pouch cells) of the battery system 104 as described below in more detail.

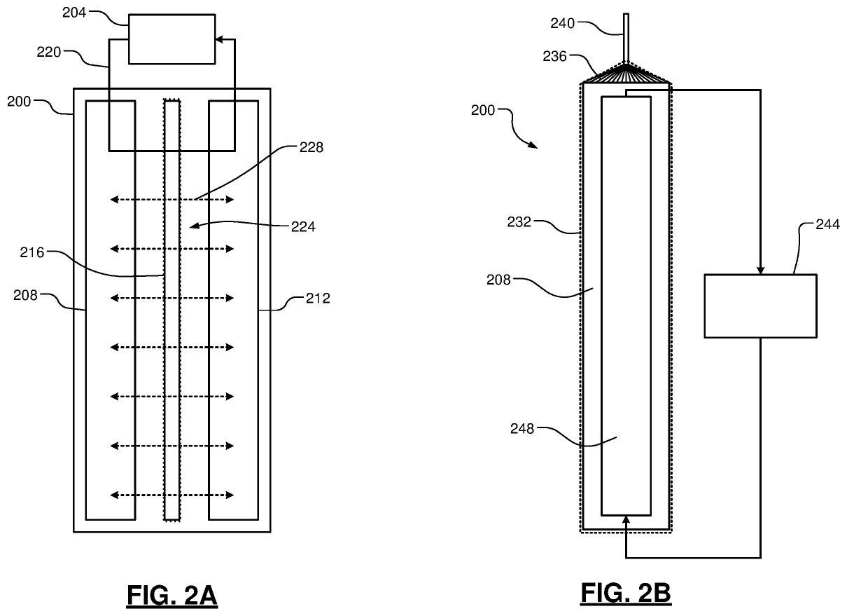

An example battery cell (e.g., a battery pouch cell) 200 for powering a load 204 is shown in FIGS. 2A and 2B. For example, the battery cell 200 corresponds to a battery of a lithium ion, Li—S, or lithium metal battery for a vehicle. As shown schematically in FIG. 2A, the battery cell 200 includes an anode 208, a cathode 212, and a separator 216 arranged between the anode 208 and the cathode 212. For example, the separator 216 is comprised of a flexible, permeable membrane.

When powering the load 204 (i.e., discharging), current flows from the anode 208 to the cathode 212 and through the load 204 in a direction indicated by arrow 220. Conversely, when charging (e.g., using a motor or other charging source), current flows from a charging source through the cathode 212 and into the anode 208 in a direction opposite the arrow 220. An electrolyte material 224 contained within the battery 200 surrounds the anode 208 and the cathode 212. The separator 216 electrically isolates the anode 208 and the cathode 212 from each other while allowing charged ions of the electrolyte material 224 to flow through the separator 216 as shown by arrows 228.

A top view of the battery cell 200 enclosed in packaging 232 is shown in FIG. 2B. In some examples, a plurality of conductive tabs (e.g., copper foils) 236 extend from an end of the anode 208 and are connected (e.g., welded) to a conductive terminal 240. The conductive tabs 236 allow current to flow between the anode 208 and the terminal 240 (i.e., to allow current to flow to and from the battery cell 200. The conductive tabs 236 are enclosed within the packaging 232.

A temperature monitoring system 244 (e.g., a component and/or function of the battery system 104, the battery control module 136, etc.) according to the present disclosure is configured to monitor respective temperatures of the battery cell 200. The temperature monitoring system 244 is configured to control the battery system 104 to reduce temperatures of the battery cell 200 or cells, disconnect the battery cell 200 or cells from other cells in the battery system 104, etc.

For example, a temperature sensing array 248 including one or more temperature sensing wires or traces is attached to a surface of the battery cell. The temperature sensing traces include LMPAs, temperature-sensitive semiconductor or dielectric material or components (e.g., diodes or thermistors), etc. The temperature monitoring system 244 supplies current or voltage to the temperature sensor array 248 and senses an output current of the temperature sensor array 248. As a temperature of the battery cell 200 increases, physical and/or electrical characteristics of the temperature sensor array 248 change, causing the sensed output current to change. In this manner, the temperature monitoring system 244 is configured to monitor temperatures of individual battery cells.

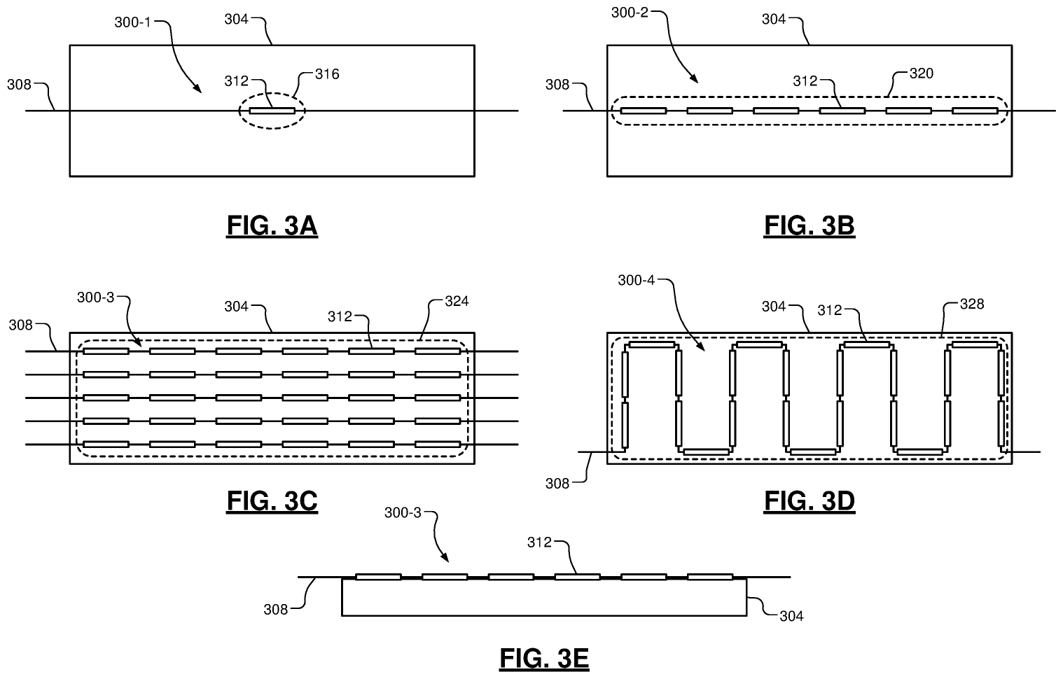

Example temperature sensing arrays 300-1, 300-2, 300-3, and 300-4 (referred to collectively as temperature sensing arrays 300) are shown in FIGS. 3A, 3B, 3C, 3D, and 3E. For example, FIGS. 3A, 3B, 3C, and 3D show the temperature sensor arrays 300 disposed on a top or upper surface of a battery cell 304 while FIG. 3E is a side view of the battery cell 304 (e.g., a side view of the example battery cell 304 shown in FIG. 3B, 3C, or 3D).

The temperature sensing arrays 300 include one or more conducting (e.g., thermally and electrically) strips (e.g., copper wires or traces) 308 each having one or more temperature sensors 312. As used herein, “temperature sensor” refers to a respective section or sections of the strips 308 sensitive to temperature such that an increase in a temperature at a corresponding point on the surface of the battery cell 304 causes a change in physical and/or electrical characteristics of the respective section. For example, the temperature monitoring system 244 supplies an input current or voltage to the temperature sensing arrays 300 and senses output currents of respective conducting strips 308. The output currents change as characteristics of the corresponding temperature sensors 312 change with temperature.

The temperature sensing array 300-1 of FIG. 3A is configured for single-point temperature monitoring of the battery cell 304. For example, the temperature sensing array 300-1 includes only a single conducting strip 308 and temperature sensor 312. Accordingly, an output current of the temperature sensing array 300-1 is indicative of a temperature change (e.g., a temperature increase) at only a single point or region 316 of the battery cell 304.

Conversely, the temperature sensing array 300-2 of FIG. 3B is configured for multi-point temperature monitoring of the battery cell 304. For example, the temperature sensing array 300-2 includes a single conducting strip 308 with a plurality of the temperature sensors 312 connected in series. As temperature changes in any portion of a region 320, temperature-sensitive characteristics of a corresponding one of the temperature sensors 312 also change. Accordingly, an output current of the temperature sensing array 300-2 is indicative of a temperature change at any point within the region 320 of the battery cell 304.

Similar to the temperature sensing array 300-2, the temperature sensing array 300-3 of FIG. 3C is configured for multi-point temperature monitoring of the battery cell 304. For example, the temperature sensing array 300-2 includes multiple conducting strips 308 arranged in parallel. Each of the conducting strips 308 includes a plurality of the temperature sensors 312 connected in series. Respective output currents of the conducting strips 308 may be independently sensed/monitored. As temperature changes in any portion of a region 324, temperature-sensitive characteristics of a corresponding one of the temperature sensors 312 also change. Accordingly, respective output currents of the conducting strips 308 of the temperature sensing array 300-3 are indicative of a temperature change at any point within the region 324 of the battery cell 304. In this manner, the temperature sensing array 300-3 is configured to sense temperatures across an entire upper surface of the battery cell 304.

Further, in the example of FIG. 3C, the output currents are indicative of a temperature change in a specific portion of the region 324. In other words, since output currents of each of the conducting strips 308 are independently sensed, each output current is indicative of temperature changes in a portion of the region corresponding to a respective one of the conducting strips 308.

Similar to the temperature sensing array 300-2, the temperature sensing array 300-4 of FIG. 3D is configured for multi-point temperature monitoring of the battery cell 304 using a single conducting strip 308 with a plurality of the temperature sensors 312 connected in series. However, in contrast to the temperature sensing array 300-2, the conducting strip 308 of the temperature sensing array 300-4 follows a serpentine path having multiple changes of direction. Accordingly, similar to the temperature sensing array 300-3, the temperature sensing array 300-4 is configured to sense temperatures in a region 328 covering an entire upper surface of the battery cell 304 but uses only a single conducting strip 308. As temperature changes in any portion of the region 328, temperature-sensitive characteristics of a corresponding one of the temperature sensors 312 also change and an output current of the conducting strip 308 are indicative of a temperature change at any point within the region 328 of the battery cell 304.

Other example configurations of the temperature sensing arrays 300 may be used. Further, although shown on an outer surface of the battery cell 304, the temperature sensor arrays 300 may be arranged on an inner surface of the battery cell 304, within/between internal layers of the battery cell 304, between a pouch lining and an outer separator layer, etc.

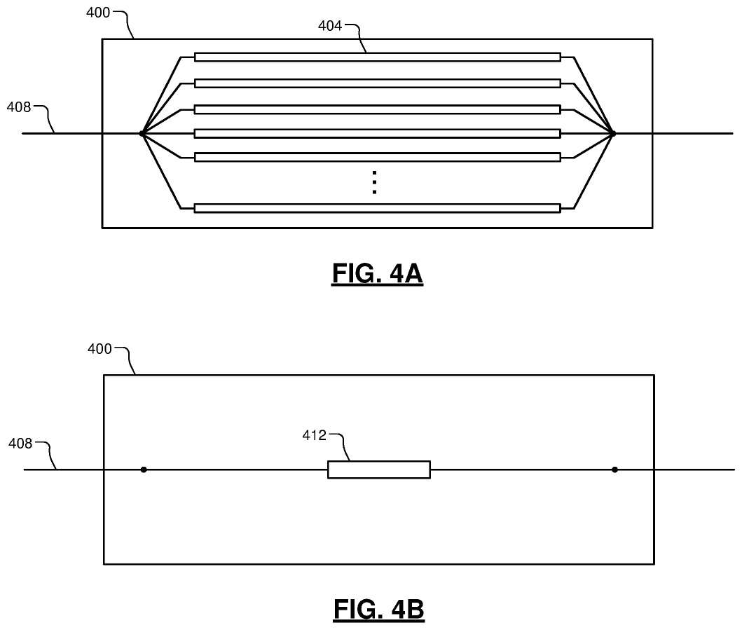

FIG. 4A shows an example temperature sensor 400 (e.g., corresponding to the temperature sensors 312) according to the present disclosure. In this example, the temperature sensor 400 includes a plurality of low melting point alloy (LMPA) strips or traces 404 connected in parallel with each other and in series with a conducting strip 408. For example only, the LMPA traces 404 are comprised of bismuth, lead, tin, cadmium, and/or indium. Other LMPAs may be used.

Each of the LMPA traces 404 has a different melting point. For example, respective melting points of the LMPA traces 404 may vary from 80 to 150 degrees Celsius. In some examples, a lowest melting point of any of the LMPA traces 404 is equal to or greater than a maximum temperature of a normal operating range of the battery cell 304.

Accordingly, each of the LMPA traces 404 melts at a different temperature. When one of the LMPA traces 404 melts, electrical connectivity between respective ends of the conducting strip 408 corresponding to the melted LMPA trace 404 is interrupted. Accordingly, an overall resistance of the temperature sensor 400 changes (e.g., increases) and a current passing through the temperature sensor 400 changes accordingly (e.g., decreases).

As temperature continues to increase, additional LMPA traces 404 melt (e.g., sequentially from top to bottom in FIG. 4A) and the resistance of the temperature sensor 400 and the current continue to change. Accordingly, the output current of the temperature sensor 400 and the corresponding conducting strip 408 indicate how many of the LMPA traces 404 have melted, which in turn indicates an approximate temperature of the battery cell in a region corresponding to the temperature sensor 400.

FIG. 4B shows another example of the temperature sensor 400. In this example, the temperature sensor 400 includes a temperature sensing component 412 connected in series with the conducting strip 408. In embodiments, the temperature sensing component 412 may include a dielectric or semiconductor material having a linear change in resistance with changes in temperature, a resistance thermometer (e.g., a resistance temperature detector (RTD)), a thermistor, a diode, etc.

Similar to the temperature sensor 400 of FIG. 4A, a resistance of the temperature sensing component 412 changes (e.g., increases or decreases) as the temperature in a corresponding region of the battery cell increases. For example, the temperature sensing component 412 is a resistance thermometer comprising one or more of platinum, copper, nickel, and tungsten. A resistance of the resistance thermometer increases as temperature increases. In another example, the temperature sensing component 412 is a thermistor comprised of a semiconductor material such as an oxide including chromium, cobalt, iron, manganese, and/or nickel. A resistance of the thermistor decreases as temperature increases.

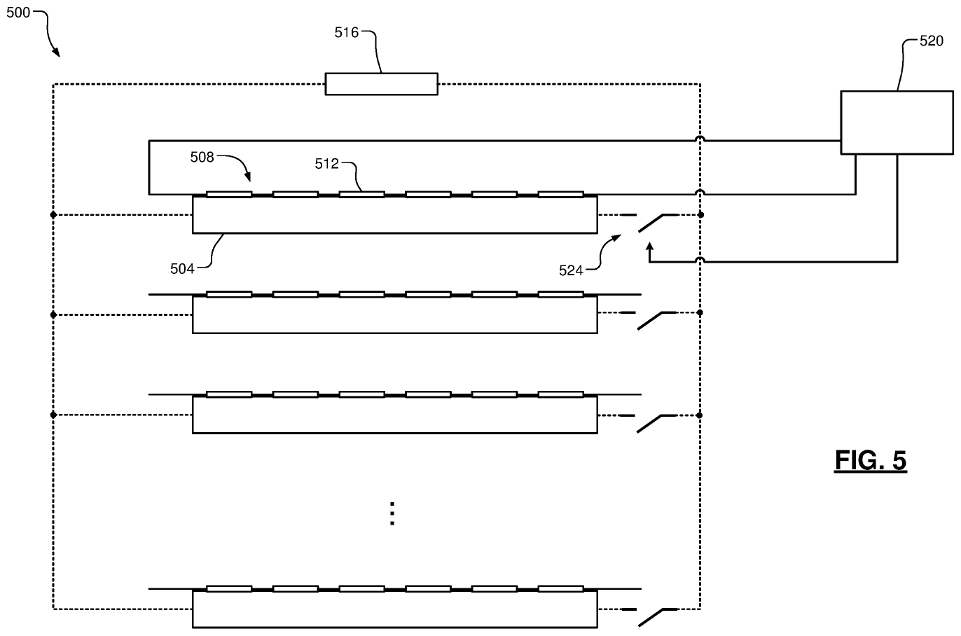

Referring now to FIG. 5, an example battery system 500 includes a plurality of battery cells 504, such as pouch cells. Although shown connected in parallel, the battery cells 504 may be connected in series or may be connected in a manner such that the battery cells 504 can be switched between parallel and series connections. Each of the battery cells 504 includes a temperature sensing array 508 according to the present disclosure. For example, the temperature sensing arrays 508 each include a plurality of temperature sensors 512 or temperature sensing components as described above in FIGS. 3A-3E, 4A, and 4B.

The battery system 500 is connected to one or more loads 516 (e.g., such as electrical loads of a vehicle). The battery cells 504 provide electrical power to the loads 516.

A temperature monitoring system 520 monitors temperatures of each of the battery cells 504. For example, the temperature monitoring system 520 supplies current or voltage to the temperature sensing arrays 508 and receives respective output currents of the temperature sensing arrays 508. The temperature monitoring system 520 monitors the output currents to determine respective temperatures of the battery cells 504 as described above. For example, as a temperature in any monitored region of the battery cells 504 increases, a resistance associated with the corresponding temperature sensing array 508 increases or decreases and the sensed current changes accordingly. In this manner, the temperature monitoring system 520 is configured to determine whether the temperature of any one of the battery cells 504 exceeds a predetermined temperature (e.g., a maximum temperature of a desired temperature range).

Each of the battery cells 504 may be individually disconnected from others of the battery cells 504 and the loads 516 (e.g., via a respective switch or switches 524. Accordingly, in response to determining that a temperature of the battery cell 504 exceeds the predetermined temperature, the temperature monitoring system 520 may control the corresponding switch 524 to disconnect the battery cells 504. In this manner, TRP can be prevented.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery system, comprising:
a battery cell; and
a temperature sensing array disposed on a surface of the battery cell, the temperature sensing array comprising:
a conducting strip; and
a plurality of temperature sensors connected in series with the conducting strip such that current flowing through the conducting strip flows through each of the temperature sensors,
wherein each of the plurality of temperature sensors has at least one characteristic that varies in accordance with temperature,
wherein the plurality of temperature sensors is distributed in different locations across the surface of the battery cell, and
wherein an output current of the temperature sensing array varies in accordance with a change in temperature in any of the different locations.

2. The battery system of claim 1, wherein the temperature sensors each include a plurality of low melting point alloy (LMPA) traces connected in parallel with each other and in series with the conducting strip.

3. The battery system of claim 2, wherein each of the LMPA traces has a different melting point.

4. The battery system of claim 1, wherein the temperature sensors each include a temperature sensing component connected in series with the conducting strip.

5. The battery system of claim 4, wherein the temperature sensing component includes at least one of a resistance thermometer, a thermistor, and a diode.

6. The battery system of claim 1, wherein the conducting strip follows a serpentine path across the surface of the battery cell.

7. The battery system of claim 1, further comprising a plurality of the temperature sensing arrays.

8. A system comprising the battery system of claim 1 and further comprising a temperature monitoring system configured to supply one of a voltage and a current to the temperature sensing array, receive the output current of the temperature sensing array, and determine a temperature of the battery cell based on the output current.

9. The system of claim 8, further comprising a plurality of the battery cells.

10. The system of claim 9, wherein the battery cells are one of pouch cells, prismatic cells, and cylindrical cells.

11. The system of claim 10, wherein the temperature monitoring system is configured to disconnect a selected one or more of the pouch cells from the battery system in response to a determination that the temperature of the one or more battery cells exceeds a predetermined temperature.

12. The system of claim 10, wherein the pouch cells are lithium-ion pouch cells.

13. A vehicle comprising the system of claim 12.

14. A system for a vehicle, the system comprising:
a battery system, the battery system comprising a plurality of pouch cells;
a plurality of temperature sensing arrays disposed on respective surfaces of each of the pouch cells, wherein each of the plurality of temperature sensing arrays comprises:
a conducting strip; and
a plurality of temperature sensors connected in series with the conducting strip such that current flowing through the conducting strip flows through each of the temperature sensors, wherein each of the plurality of temperature sensors has at least one characteristic that varies in accordance with a temperature of the pouch cell, wherein the plurality of temperature sensors is distributed in different locations across the respective surface of the pouch cell, and wherein an output current of the temperature sensing array varies in accordance with a change in temperature in any of the different locations; and
a temperature monitoring system configured to receive the output currents of each of the temperature sensing arrays and determine the temperatures of the pouch cells based on the output currents.

15. The system of claim 14, wherein each of the plurality of temperature sensors includes a plurality of low melting point alloy (LMPA) traces connected in parallel with each other and in series with the conducting strip.

16. The system of claim 15, wherein each of the LMPA traces has a different melting point.

17. The system of claim 14, wherein each of the plurality of temperature sensors includes at least one of a resistance thermometer, a thermistor, and a diode.

18. The system of claim 14, wherein the conducting strip follows a serpentine path including multiple changes in direction across the surface of the pouch cell.

19. The system of claim 14, wherein the plurality of temperature sensors are connected in parallel across a full width of the pouch cells.

20. The system of claim 14, wherein the temperature monitoring system is configured to disconnect a selected one or more of the pouch cells from the battery system in response to a determination that the temperature of the pouch cell exceeds a predetermined temperature.
